(19) United States
(12) Patent Application Publication
(10) Pub. No.: US 2015/0188977 A1
(43) Pub. Date: Jul. 2, 2015

(54) Verifying Content Rendering on a Client Device

(71) Applicant: GOOGLE INC., Mountain View, CA (US)

(72) Inventors: Alex Berry, Sydney (AU); Alan Gordon Doubleday, Macquarie Park (AU); Jordan Bayliss-Mcculloch, Waterloo (AU)

(73) Assignee: GOOGLE INC., Mountain View, CA (US)

(21) Appl. No.: 14/071,102

(22) Filed: Nov. 4, 2013

(51) Int. Cl. H04L 29/08

(52) U.S. Cl. CPC H04L 67/02

(57) ABSTRACT

Accuracy of rendering server-provided content at a client device can be automatically verified. To this end, content can be provided in a non-image format to the client device via a communication network, such that the client device renders the content to generate a rendered image. The content is rendered using a canonical rendering component to generate an expected rendered image. An expected result corresponding to the expected rendered image is generated, and the expected result can be be compared to verification data generated based on the rendered image to determine whether the client device correctly generated the rendered image.

### FIELD OF THE DISCLOSURE

The present disclosure relates to distribution of content for rendering on client devices and, more particularly, to automatically verifying accuracy of rendering of server-provided content on a client device.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Numerous servers on the Internet or other communications networks provide graphics content to client devices in a format that requires rendering. For example, rather than transmitting large bitmaps, a server can transmit static or interactive graphics content to a client device using such efficient standards as, for example, Web Graphics Library (WebGL), Virtual Reality Modeling Language (VRML), X3D, etc. The client device then renders the graphic content using hardware, firmware, and software components. More particularly, the client device can include a certain Graphics Processing Unit (GPU) chipset, a certain version of WebGL software and, on a higher level, a certain type and version of a web browser or another software application. These and other factors can affect pixel output of the rendering process. As a result, different client devices often render the same graphics content differently, with many forms of output being incorrect.

Many users prefer not to report rendering errors to graphics content providers. Moreover, users often do not notice small rendering errors at all. It is therefore difficult for providers of graphics content to know how well their content is displayed on various devices, and whether their content is effectively incompatible with certain devices or device configurations.

### SUMMARY

Generally speaking, a server that provides graphics content for rendering by various client devices renders representative portions of the content using rendering components that represent various canonical browsers (or other software applications that can render content on the client device). The server then generates a hash or other compact representation of the rendered portion. When a certain client device renders the same portion of the content, the client device applies the same hash function to generate verification data. The server and the client device then compare these results of hashing, on the server or on the client device, to determine whether the client device renders content as expected.

In particular, one embodiment of the techniques of this disclosure is a computer-implemented method for verifying accuracy of rendering server-provided content at a client device. The method includes providing renderable content in a non-image format to the client device via a communication network, where the client device renders the renderable content to generate a rendered image. The method further includes rendering the content using a rendering component to generate an expected rendered image, causing generation of verification data related to the client device's rendering of the renderable content, and causing generation of a comparison result derived based at least in part on the received verification data and the expected rendered image.

According to another embodiment, a system for verifying accuracy of rendering of server-provided content includes one or more processors and a non-transitory computer-readable memory coupled to the one or more processors and storing instructions. When executed by the one or more processors, the instructions cause the system to receive content in a non-image format from a server via a communication network, render the received content to generate a rendered image, generate verification data based on the rendered image, and determine whether the rendered image was generated correctly based at least in part on (i) the verification data and (ii) an expected rendered image generated at the server.

According to yet another embodiment, a non-transitory computer-readable medium stores instructions that, when executed by one or more processors, cause the one or more processors to (i) obtain map data for rendering a digital map of a geographic area, (ii) render the map data using a plurality of rendering components to generate a plurality of respective expected rendered images, where each of the plurality of rendering components corresponds to a different web browser, (iii) generate expected results based on the plurality of expected rendered images, (iv) store the expected results in a database, and (v) verify accuracy of rendering of the map data at client devices using the stored expected results.

### BRIEF DESCRIPTION OF THE DRAWINGS

FIG. 1 is a block diagram of an example system in which the techniques for verifying rendering on a client device can be implemented;

FIG. 2 schematically illustrates example verification of rendered content by hashing a portion of the image, which can be implemented in the system of FIG. 1;

FIG. 3 is a flow diagram of an example method, which can be implemented in the server of FIG. 1, for generating expected rendering results for a set of canonical software applications;

FIG. 4 is a flow diagram of an example method, which can be implemented in the server of FIG. 1, for verifying rendering at a client device by comparing verification data to expected rendering results; and

FIG. 5 is a flow diagram of an example method, which can be implemented in the client device of FIG. 1, for generating verification data for rendered content.

### DETAILED DESCRIPTION

Using the techniques of this disclosure, a provider of graphics content and/or the user of a client device can efficiently, reliably, and securely determine whether a client device renders server-provided content correctly. The client device renders content received from a server and uses hashing or another suitable technique to derive compact verification data based on the rendered content. The server renders the same content and applies the same technique as the client device to generate its own version of the verification data, referred to below as “expected result.” The server or the client device then can compare the verification data to the expected result to determine whether the client rendered the content as expected. To this end, the server can send the expected result to the client along with the content, or the client device can send the verification data to the server.

Because the server and the client device only exchange the compact verification data or the equally compact expected result, the technique requires little bandwidth. Moreover, the client device can transmit the verification data to the server without jeopardizing the user's privacy.

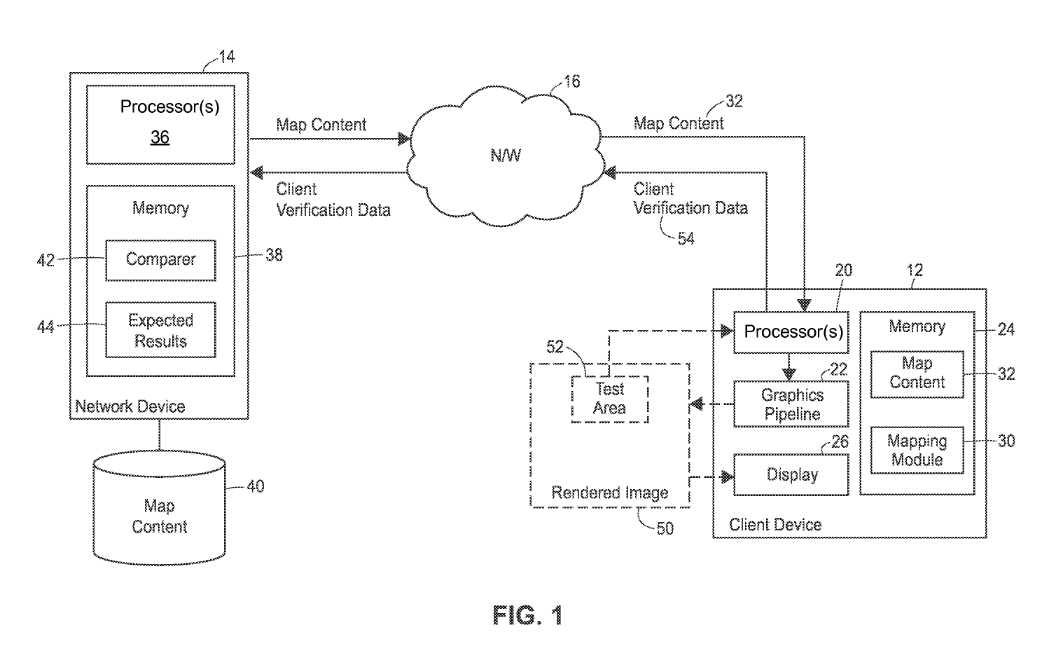

For simplicity, the examples discussed below with reference to FIGS. 1-5 relate to digital maps that can be rendered based on map data transmitted over a communication network in a non-image format. These examples also focus on web browsers that display digital maps within browser windows. However, it will be understood that these techniques also can be applied to other types of content and other types of applications.

FIG. 1 illustrates an example communication system 10 in which a client device 12 and a server 14 communicate via a network 16 to efficiently and securely verify rendering at the client device 12. The client device 12 can include one or more instances of processor 20, a graphics pipeline 22, a computer-readable memory 24, and a display device 26. The memory 24 can be made up of any suitable number of persistent and non-persistent memory modules, and can store instructions for various software applications which execute on the one or more processor(s) 20. For example, the memory 24 can store a mapping module 30 that renders map content 32 received from the server 14. The mapping module 30 can be a dedicated software application that provides an interactive digital map or a web browser application, for example. The map content 32 can include instructions and parameters for generating a digital map. For example, the map content 32 can describe map features in a vector graphics format using definitions of primitives made of vertices, definitions of textures, and indications of how textures are mapped to feature geometry.

The graphics pipeline 22 can be a OpenGL or DirectX pipeline, for example. In general, the graphics pipeline 22 can include or be implemented in one or several graphics processing units (GPUs), firmware components, and software components, each of which can be configured differently in different implementations of the client device 12. In an example implementation, the graphics pipeline 22 operates similar to an assembly line, with multiple processing steps performed in sequence. At various stages, the graphics pipeline 22 can perform such operations as vertex space transformation for mapping vertices to screen space, generating texture coordinates for texturing primitives, calculating colors for vertices and fragments, rasterizing to generate pixels for output on the display 26 or storage in a bitmap format, etc. Further, in some embodiments, the graphics pipeline 22 is implemented in the one or more processor(s) 20, which can be general-purpose processors.

The server 14 can include one or more instances of a processor 36, which can be generally similar to the one or more processor(s) 20, and a non-transitory computer-readable memory 38. The server 14 can be coupled to a map content database 40 implemented in any suitable manner. The memory 38 stores expected results 42, which can be a single record, a data structure, or a database of records, depending on the implementation. The memory 38 also stores instructions that make up a comparator module 44 configured to compare the expected results 42 to verification data provided by the client device 12.

In operation, the client device 12 sends a request for map content 32 to the server 14. In response, the server 14 transmits the map content to the client device 12. The client device renders the received map content 32 to generate a rendered image 50, which can be displayed via the display 26. The client device 12 also selects a test area 52 according to a certain agreed-upon scheme for generating verification data 54. For example, the client device 12 and the server 14 can agree that the test area 52 is 40 pixels long and 40 pixels wide, and is positioned in the lower left of the rendered image 50. Alternatively, the server 14 can specify the location and size of the test area 52. As yet another example, the client device 12 can select the test area 52 and specify the location and size of the test area 52 to the server 14.

In any case, the client device 12 can generates and transmits verification data 54, which can be a hash of the bitmap defining the test area 52. As discussed in more detail below, the client device 12 and the server 14 can use a suitable near-duplicate detection technique so as to tolerate sufficiently small differences in rendering. The extent of tolerable differences can be expressed as a configurable threshold value, for example. The client device 12 can transmit the verification data 54 along with browser type identification to the server 14, according to one implementation. The browser type identification can be, for example, the user-agent field specified by the Hypertext Transfer Protocol (HTTP). The server 14 can compare the verification data 54 to the expected results 44, which can be generated using for the same test area 52 using graphics component that the server 14 expects the client device 12 to use. More specifically, the server 14 can generate the expected results 44 using rendering software corresponding to the browser type specified by the client device 12. Depending on how closely the verification data 54 corresponds to the expected results 44, the server 14 can generate an indication that the client device 12 rendered the map content 32 correctly or, conversely, that the client device 12 did not render the map content 32 as expected. In some implementations, the server 14 also notifies the client device 12, which in turn generates a warning for the user.

More generally, the server 14 can generate the expected results 44 according to any number of parameters specific to the client device 12. For example, the user of the client device 12 can express consent that he or she is willing to share the details of the graphics pipeline 22, such as the manufacturer of the GPU, the version of firmware or software, etc. In this manner, the server 14 can match the verification data 54 to the expected results 44 more precisely. Moreover, the server 14 in this manner can determine which cards or versions of software are incompatible (or not fully compatible) with the map content 32.

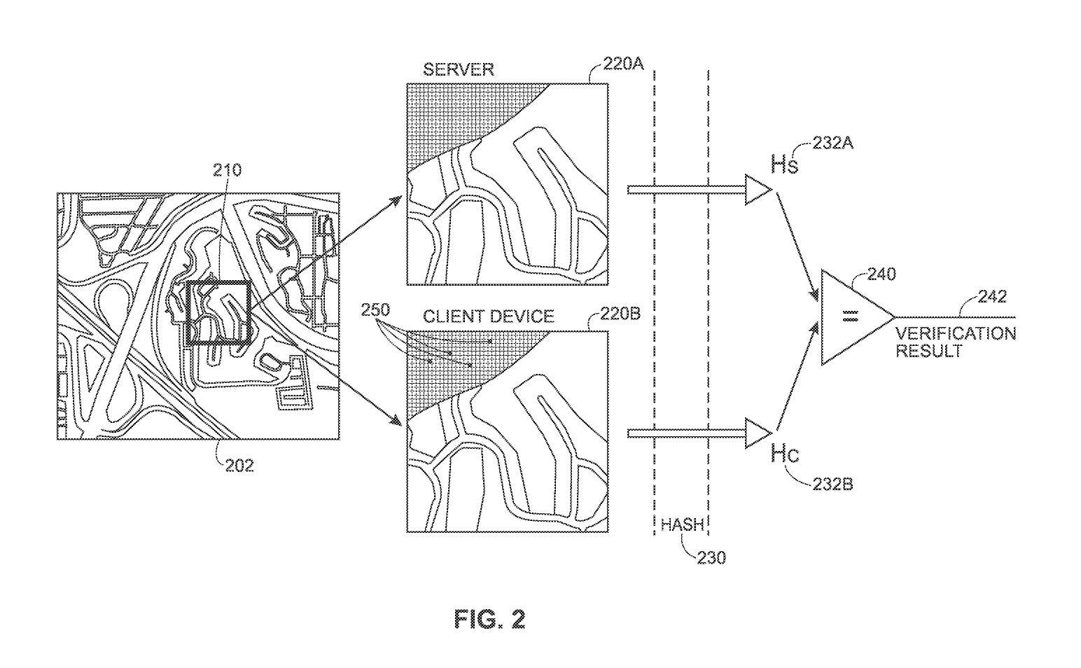

For additional clarity, FIG. 2 depicts a block diagram of the verification technique described above. An example bitmap image 202 depicting a map of a geographic area can be generated by rendering content stored in a non-image format, such as vector data, for example. Box 210 delimits an area which a server and client devices can use for verifying the accuracy of rendering. As illustrated in FIG. 1, the portion of the bitmap image 202 within the box 210 can be rendered at a server as image 220A and at a client device as image 220B. Referring back to FIG. 1, for example, the server 14 can render the image 220A and the client device 12 can render the image 220B. More generally, any number of client devices can generate respective versions of the image 220A.

The images 220A and 220B pass through a hashing stage 230 to generate server-side hash 232A and a client-side hash 232B, respectively. As one example, the hashing stage 230 can be implemented as a software function that implements a near-duplicate detection function using, for example, Locality Sensitive Hashing (LSH). The hashing stage 230 in other implementations can implement other hashing schemes. More generally, the stage 230 can implement any technique for generating a compact representations of data sets of subsequent comparison.

The server-side hash 232A and a client-side hash 232B are compared at a verification stage 240 to generate a verification result 242. In this example, several pixels in the image 220B differ from the corresponding pixels in the image 220A. These differences are schematically illustrated as solid squares representing non-matching pixels 250.

The non-matching pixels 250 can differ from the corresponding pixels in the image 220A in color and/or level of transparency, for example. Further, the images 220A and 220B in some cases can differ in the placement of vertices, in which case the non-matching pixels 250 can represent a certain displacement of the corresponding pixels.

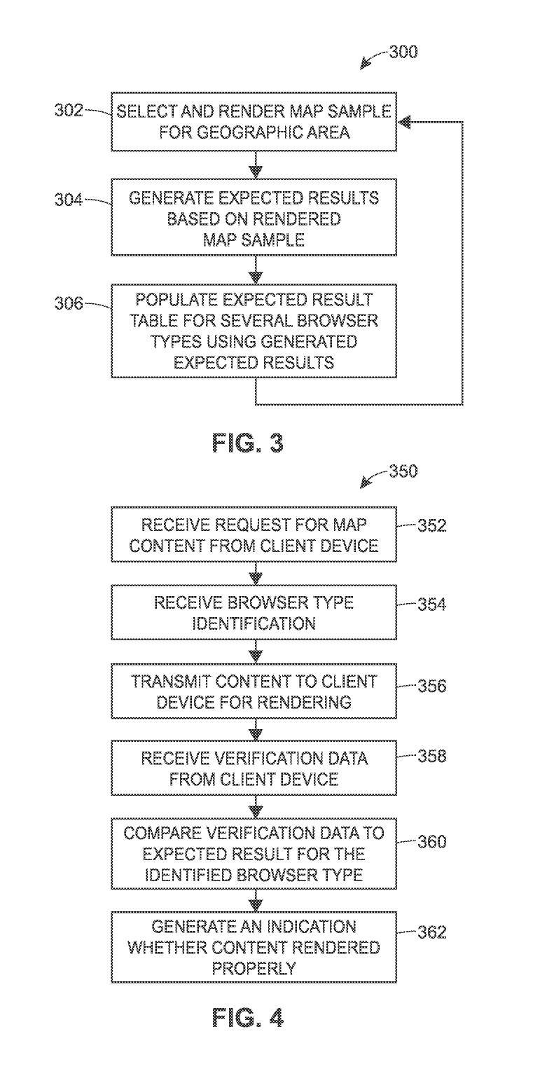

Now referring to FIG. 3, an example method 300 for generating expected rendering results for a set of canonical software applications can be implemented on one or more processor(s), in a single server or a group of servers, for example. The method 300 can be executed in real time or as a batch process to populate a database of expected results.

At block 302, a map sample for a geographic area is selected and rendered for use in verifying the accuracy of rendering at client devices. This map sample can be similar to the test area 52 of FIG. 1. The map sample can be selected according to any suitable principle. As indicated above, the map sample can be a certain area of an image that is rendered based on the map content which a client device specifically requested. In another implementation, the map sample can be a map tile at a certain zoom level. Thus, for example, if a typical display of a geographic area at zoom level Z is made up of 100 tiles, the map sample can be one such tile.

At block 304, expected results are generated based on the rendered map sample. The expected results can be generated for a set of canonical web browsers. Depending on the configuration, there can be multiple expected results for each canonical web browser to account for different hardware components compatible with the web browser, for example. The expected results can be generated by rendering the sample selected at block 302 and hashing the result so as to store a compact representation of the expected image. For example, a near-duplicate hashing function can be used.

The expected results then can be stored (block 306) in a table, list, database, etc. on a computer-readable medium, as illustrated in FIG. 1. If additional expected results need to be generated desired, the flow proceeds back to block 302, where another map sample is selected. Otherwise, the method 300 completes.

Next, FIG. 4 illustrates a block diagram of an example method 350 for verifying rendering at a client device. The method 350 can be implemented in the comparer module 42. Depending on the embodiment, the methods 300 and 350 can be implemented in the same device or different devices, on one or more processor(s). If desired, the method 300 can be executed on a separate schedule to generate expected results, and the method 350 can be a real-time method which a server executes using the expected results generated by the method 300.

The method 350 begins at block 352, when a request for map data is received from a client device (such as the client device 12, for example). Browser type identification is received at block 354. As indicated above, the client device can also provide additional information, should the user operate appropriate settings to allow the client device 12 to do so. At block 356, the requested content is transmitted to the client device in a non-image format. In some implementations, an indication of which portion of the rendered content (the test area) is to be used for verification is transmitted to the client device as well. For example, the indication can specify the geographic coordinates of a square region and the zoom level at which the map content is to be rendered and hashed for verification purposes.

Verification data is received from the client device at block 358. The verification data can include a hash of the rendered test area. The received verification data is compared to the corresponding expected result at block 360, and indication of whether the client device rendered the map as expected is generated at block 362.

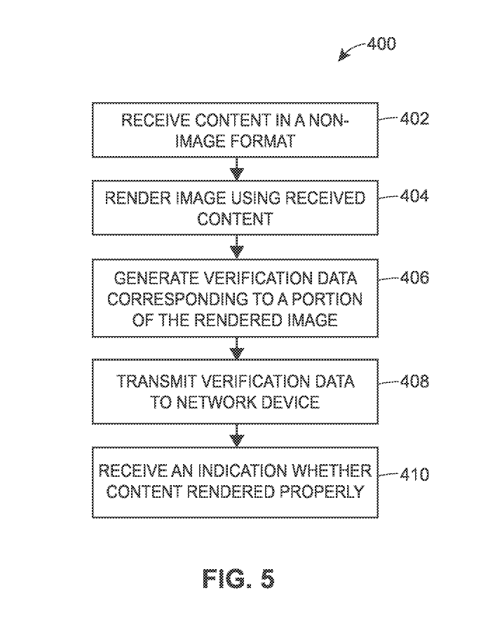

Next, FIG. 5 is a flow diagram of an example method 400 for generating verification data for rendered content, which can be implemented in the client device 12 or another suitable client device. In general, the method 400 can be executed on one or more processor(s). At block 402, content is received from a server (e.g., the server 14) in a non-image format. An appropriate image is rendered using the received content 404. In particular, data can be interpreted and rendered to generate a bitmap for storage or display via the display 26. Verification data is generated using a hash function or another suitable technique at block 406. As discussed above, the client device need not apply the hash function to the entire content but only to a selected portion of the content, according to some embodiments. The verification data is transmitted to the network device 408, and an indication of whether the client had rendered the content properly is received at block 410.

In other embodiments, the client device can receive an appropriate expected rendering result, which may be provided for the specific software application and/or rendering pipeline of the client device. The client then can compare the expected result to the verification data locally. More generally, comparing the verification data to the expected result can be implemented on the client device, the server, both, or even on another host.

Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor- implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self- consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for testing graphics programs on a graphics card through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for verifying accuracy of rendering server-provided content, the method comprising:
providing, by one or more processors, renderable content in a non-image format to a client device via a communication network, wherein the client device renders the renderable content to generate a rendered image;
rendering, by the one or more processors, the renderable content using a rendering component to generate an expected rendered image;
causing generation of verification data related to the client device's rendering of the renderable content; and
causing generation of a comparison result derived based at least in part on the received verification data and the expected rendered image.

2. The method of claim 1, further comprising:
generating, by the one or more processors, an expected result based on the expected rendered image;
wherein causing the generation of the comparison result includes causing the expected result to be compared to the verification data.

3. The method of claim 2, wherein causing the generation of the comparison result includes:
receiving, by the one or more processors, the verification data from the client device, and comparing, by the one or more processors, the expected result to the verification data.

4. The method of claim 2, wherein causing the generation of the comparison result includes:
providing, by the one or more processors, the expected result to the client device, wherein the client device compares the expected result to the verification data.

5. The method of claim 2, wherein generating the expected result includes:
applying, by the one or more processors, a hash function to the expected rendered image to generate the expected result;
wherein the client device applies the same hash function to the rendered image to generate the verification data.

6. The method of claim 5, wherein:
the hash function generates proximate hash values based on proximate inputs, and causing the expected result to be compared to the verification data includes using a similarity threshold.

7. The method of claim 1, wherein the content is described in a vector graphics format.

8. The method of claim 1, wherein rendering the content to generate the expected rendered image includes rendering the content so as to match a screen resolution of the client device.

9. A system for verifying accuracy of rendering server-provided content, the system comprising:
one or more processors;
a non-transitory computer-readable memory coupled to the one or more processors and storing thereon instructions that, when executed by the one or more processors, cause the system to:
receive content in a non-image format from a server via a communication network;
render the received content to generate a rendered image;
generate verification data related on the rendered image; and
determine whether the rendered image was generated correctly based at least in part on (i) the verification data and (ii) an expected rendered image generated at the server.

10. The system of claim 9, wherein to determine whether the rendered image was generated correctly, the instructions cause the system to:
receive, from the server, an expected result generated based on the rendered image, and
compare the expected result to the verification data.

11. The system of claim 9, wherein to determine whether the rendered image was generated correctly, the instructions cause the system to:
provide the verification data to the server, and
receive, from the server, an indication of whether the rendered image was generated correctly.

12. The system of claim 9, wherein to generate the verification data, the instructions cause the system to :
apply a hash function to the rendered image to generate the verification data; wherein:
the server (i) renders the content to generate an expected rendered image and (ii) applies the same hash function to the expected rendered image to generate an expected result, and
to determine whether the rendered image was generated correctly, the verification data is compared to the expected result.

13. The system of claim 13, wherein the hash function generates proximate hash values based on proximate inputs, and wherein to determine whether the rendered image was generated correctly, the expected result is compared to the the verification data using a similarity threshold.

14. The system of claim 9, wherein the instructions further cause the system to:
receive, from the server, an indication of which portion of the rendered image is to be used in generating the verification data, wherein the indicated portion is smaller than the entire rendered image; and
wherein the instructions cause the system to generate the verification data based only on the indicated portion of the rendered image.

15. The system of claim 9, wherein to generate the verification data, the instructions cause the system to capture a screenshot including the rendered image on a screen of the client device.

16. A non-transitory computer-readable medium storing thereon instructions that, when executed by one or more processors, cause the one or more processors to:
obtain map data for rendering a digital map of a geographic area;
render the map data using a plurality of rendering components to generate a plurality of respective expected rendered images, wherein each of the plurality of rendering components corresponds to a different web browser;
generate expected results based on the plurality of expected rendered images;
store the expected results in a database; and
verify accuracy of rendering of the map data at client devices using the stored expected results.

17. The computer-readable medium of claim 16, wherein the instructions cause the one or more processors to generate the expected results using a hash function.

18. The computer-readable medium of claim 16, wherein the instructions further cause the one or more processors to:
receive, from a client device, a request for the map data and an indication of a web browser used to render the map data;
retrieve, from the database, the expected result corresponding to the indicated web browser;
provide the map data to the client device, wherein the client device renders the map data to generate a rendered image; and
provide the expected result to the client device for determining the client device correctly rendered the map data.

19. The computer-readable medium of claim 16, wherein the instructions further cause the one or more processors to:
receive, from a client device, a request for the map data and an indication of a web browser used to render the map data;
provide the map data to the client device, wherein the client device renders the map data to generate a rendered image;
retrieve, from the database, the expected result corresponding to the indicated web browser;
receive, from the client device, verification data generated based on the rendered image; and
compare the expected result to the verification data to determine whether the client device correctly rendered the map data.

20. The computer-readable medium of claim 16, wherein the map data conforms to a vector graphics format.
